(19) United States
(12) Patent Application Publication
(10) Pub. No.: US 2015/0040474 A1
(43) Pub. Date: Feb. 12, 2015

(54) PLANT POT WITH ELEVATED VENTILATION HOLE

(71) Applicants: Bret E. Lee, Alhambra, CA (US); Jason Jen Sen Lee, Los Angeles, CA (US)

(72) Inventors: Bret E. Lee, Alhambra, CA (US); Jason Jen Sen Lee, Los Angeles, CA (US)

(21) Appl. No.: 13/961,777

(22) Filed: Aug. 7, 2013

(51) Int. Cl. A01G 9/02

(52) U.S. Cl. CPC A01G 9/02; A01G 9/021
USPC 47/65.6; 47/65.5; 47/65.7

(57) ABSTRACT

A plant pot with Elevated Ventilation Hole (EVH) comprises a pot section having a bottom wall and a side wall surrounding and connected to the bottom wall, the bottom wall and the side wall together defining an accommodation space for accommodating soil and plants, a bottom surface of the bottom wall having an inward recess portion with an adjustable height, the height being capable of manually adjusted to form a ventilation hole correspondingly, wherein a position of the ventilation hole corresponds to the adjustable height.

### TECHNICAL FIELD

The present disclosure relates to plant pots. More particularly, the present disclosure relates to a plant pot with an improved structure that provides a more suitable environment for plant growth.

### DESCRIPTION OF RELATED ART

Many people have found that traditional planting pots are not good enough for plants to grow well. For plants to grow well in pots, it is necessary to provide plants with sufficient air, water and nutrition. Traditional pots have a hole on the bottom, to provide air to the root of plants therein. Because of this hole, very limited water can be retained and vital plant nutrition will be stripped away with each watering. Therefore, potted plants need to be frequently cared for and watered in order to grow well. Many people find it is not an easy task.

The growth of plants is highly influenced by the development of the roots. As recognized by the skilled person, one of the important factors which contribute to plant growth is the sufficiency of the water supply. In order to establish a water-rich environment for the plant roots, the plant pots are typically improved by using a base container section in which water accumulates as excess water poured into the soil seeps through the holes in the bottom of the pot. These plant pots have the advantage that water in the base container section can be absorbed by the plant roots through capillary action over an extended period of time. However, since the base container is very shallow, the amount of water that can be kept therein is limited and will not be sufficient to keep the pot soil wet enough for healthy root development. Moreover, since water is directly filled to the base container, only a lower portion of the pot soil can be kept moist. Over time, the upper portion of the pot soil will dry out and plants will not get enough water to grow. This situation is very unfavorable for the plants, especially during the early stage of trans-plantation when plants are small and the roots are still weak and not long enough to reach the bottom of the pot. Trans-planted plants could die from drought even if the base container still has water in.

In addition to the pot with a base container section as aforementioned, a plant pot having an integral base container is known. Such a plant pot is provided with a recess allowing access to the base container to store water. Nevertheless, such access is restricted and there is difficulty in pouring the water therein. Besides the inconvenience, the manufacturing cost is also increased because of its complicated design.

In order to address the mentioned problem, U.S. Pat. No. 5,638,638 describes a flower pot with accessible watering base, which is schematically shown in FIG. 1. Referring to FIG. 1, the flower pot 110′ is shown as having an upper pot section 112′ comprising a truncated conical wall 116′ closed at its bottom by a wall 118′ formed with a plurality of slots 120′ and a base section 114′, which are locked together by the cooperation of the pegs 136′ and the crucible opening 138′. According to the description of U.S. Pat. No. 5,638,638, with the aid of the lip 130′ and the conical shaped recess 144′, water is free to flow within the reservoir formed within the base section 114′ beneath the upper pot section 112′, and the water in the base section 114′ will seep upward only through the crucible opening 138′ to feed the roots. Thus, the water in the reservoir can be kept filled to its full capacity thereby providing several days' or weeks' supply of water at one time. In case that water is directly poured into the top of the upper pot section 112′, all excess water will run through the soil and drop into the base section 114′ through the slots 120′ in the bottom wall of the upper pot section 112′. Nevertheless, the flower pot 110′ as described in U.S. Pat. No. 5,638,638 has a relatively complicated structure, which is difficult to manufacture and increases the cost thereof.

TW Patent No. 498715 also describes an improved flower pot for reserving water therein. With reference to FIG. 2, which shows the perspective view of an improved flower pot 210′ having a plurality of cylinders 220′ protruding from the bottom 211′ thereof. Each of the plurality of cylinders 220′ is provided with a hole 222′ passing therethrough, and has a height H′ measured from the bottom 211′ of the flower pot 210′. When water is poured into the flower pot 210′, a sufficient amount of water will accumulate within the flower pot 210′, up to a level of H′, while the excess water will flow out of the flower pot 210′ through the hole 222′, so as to maintain the soil in the flower pot 210′ wet to enhance the growth of the plant. Such a flower pot 210′ is advantageous for having a plurality of drain holes 222′ formed at a height H′ from the bottom 211′ of the pot 210′ to reserve the water therein; however, the height H′ is fixed and determined upon manufacture, and thus cannot be applicable for the varieties of plants. FIG. 2 shows four cylinders 220′, which is more than needed. The excess of cylinders increases the materials needed and manufacturing cost.

Plant roots need not only water but also air to facilitate plant growth. However, too much water accumulated in the bottom portion of the plant pot may impede the air from circulating in and out of the plant pot and thus damage the plant roots, e.g. causing the roots to rot. In this circumstance, the plant growth will be adversely affected. For this end, TW Patent No. M254077 provides a further design of flower pot 340′, which is shown in FIG. 3, to enhance the air circulation. Referring to FIG. 3, the flower pot 340′ has plural holes 341′ formed on the platform 347′ thereof. These holes 341′ are arranged in a matrix of rows and columns, which may facilitate the flow of air in and out of the flower pot 340′. The dimension of platform 347′ is slightly smaller than the area enclosed by the sidewalls 349′, and is inwardly raised from the bottom of the pot, such that a circular recess 348′ is formed at the bottom to reserve water therein. However, the depth of the bottom reservoir is shallow and will only be able to reserve a small amount of water. Such flower pot 340′, humidifies only the bottom of the pot soil by natural water evaporation. It is hard for vapor to go through the entire pot. FIG. 3 shows twelve holes on the bottom of a pot. The excess of holes on the bottom will let water drain out faster. It will not reduce the watering frequency. With a dozen holes on the bottom, it will not be able to hold the soil well. Loss of soil may happen during watering or when moving the pot.

It is also difficult to enable the air to circulate in and out of the bottom of the plant pot when the water level accumulated in the lower portion of the pot is higher than the bottom of the pot. It will then block the air flow into the pot from the bottom. In this regard, the plant roots may not get both sufficient water and air at the same time. If both the top and bottom soils in a plant pot dry much faster than the soil in the center section of the pot, it results in an unnatural condition for the development of the plant roots. A compromise between the unhindered air circulation and the sufficient water accumulation is required for the plant to grow well.

Another problem is that, when water flows through the soil and out of the plant pots, the vital minerals and nutrients contained in the soil will be stripped with each watering. Over a longer period of time, the pot soil will be less nutritional for the plants within it.

A couple of earlier patented inventions have already sought to improve the function of planting pots. However, there is still more room for further improvement, as stated in the aforementioned. While the above mentioned patented designs improved some functions of traditional pots, they created other problems. Their complicated designs increase manufacturing costs by using more materials and more processing procedures. The consideration of manufacturing cost is as important as that of function for patent designing. It is the key factor in bringing a good design to the market, as that is the ultimate purpose of any invention. Any patent product needs to be designed in its simplest possible form, to save material, energy, be environmentally friendly and cost effective so it can be more readily accepted by the general consumer, especially for low price merchandise, such as planting pots.

In light of the foregoing, there is a need for a plant pot with an elevated ventilation hole (EVH) in order to provide an improved environment for the development of the plant roots and further facilitating the growth of the plants. The requirements of the water reserving space volume within the pot, in order to retain water and nutrients while providing air to the inner part of it may differ for various kinds of plant species.

In addition, a low manufacturing cost is also essential to bring an invention to the market.

### SUMMARY OF THE INVENTION

The present invention discloses a plant pot with an Elevated Ventilation Hole (EVH). The plant pot with an EVH is capable of providing an improved environment for the development of plant roots, further facilitating the growth of the plants.

According to one aspect of the present invention, a plant pot with an EVH is provided, which includes a pot section having a bottom wall and a side wall extending from and surrounding the bottom wall, wherein the bottom wall and the side wall together define an accommodation space for receiving soil and plants therein. According to the invention, the bottom wall is provided with a ventilation section extending therefrom and toward the inside of the accommodation space. The ventilation section has a hollow opening at the end thereof distal to the bottom wall or it could be initially manufactured in an enclosed form for a hole to be cut open later. The ventilation section can also be cut down to a desirable height measured from the bottom wall, at a position corresponding to the height within the accommodation space.

Preferably, the ventilation section should be initially manufactured with a height that is smaller than the side wall, thus the position of the ventilation hole with respect to the pot section may be determined or adjusted as desired. Preferably, the ventilation section can be separated by means of trimming, cutting, sawing, snapping, twisting or a combination thereof.

Preferably, the ventilation section is provided with a plurality of trim lines which are formed thereon and spaced apart from each other.

Preferably, the ventilation section can be separated at one of the trim lines so as to adjust the height and thus the position of the ventilation hole.

Preferably, the ventilation section has a conical shape, a polygonal cylindrical shape, a cylindrical shape or an irregular shape.

Preferably, the ventilation section has a thickness thinner than that of the surrounding and bottom walls.

Preferably, the ventilation section is made of the same material as that of the pot section.

Preferably, the ventilation section can also be made of a different material from that of the pot section.

Preferably, the ventilation section is made of paper, plastic, wood, clay, ceramic or foam materials.

Preferably, the plant pot further includes a water collecting reservoir positioned at the bottom of the plant pot for collecting excess water flowing out of the plant pot.

Preferably, there is only one ventilation section in each pot, to keep the material and manufacturing costs to a minimum.

Preferably, the ventilation section is made in a conical shape so that several empty pots could be stacked on and nested with one another, so as to save storage space and costs for transportation.

### BRIEF DESCRIPTION OF THE DRAWINGS

The disclosure is able to be more fully understood by reading the following detailed description of the embodiment, with reference made to the accompanying drawings as follows:

FIG. 1 is a perspective view schematically showing a conventional flower pot in the prior art;

FIG. 2 schematically shows another conventional flower pot in the prior art;

FIG. 3 is a perspective view schematically showing a further conventional flower pot in the prior art;

FIG. 4A to FIG. 4C are schematic representation views showing a plant pot in accordance with a first embodiment of the present disclosure;

FIG. 5 is a schematic representation view showing a plant pot in accordance with a second embodiment of the present disclosure; and

FIG. 6 shows a schematic representation view showing a plant pot in accordance with a third embodiment of the present disclosure.

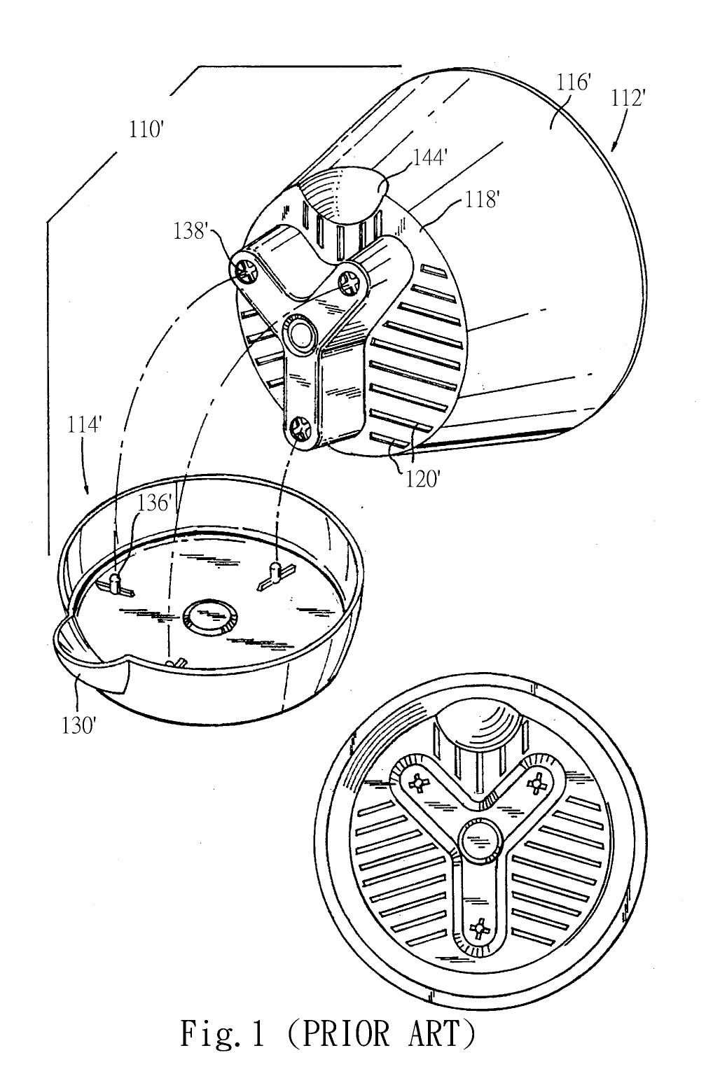

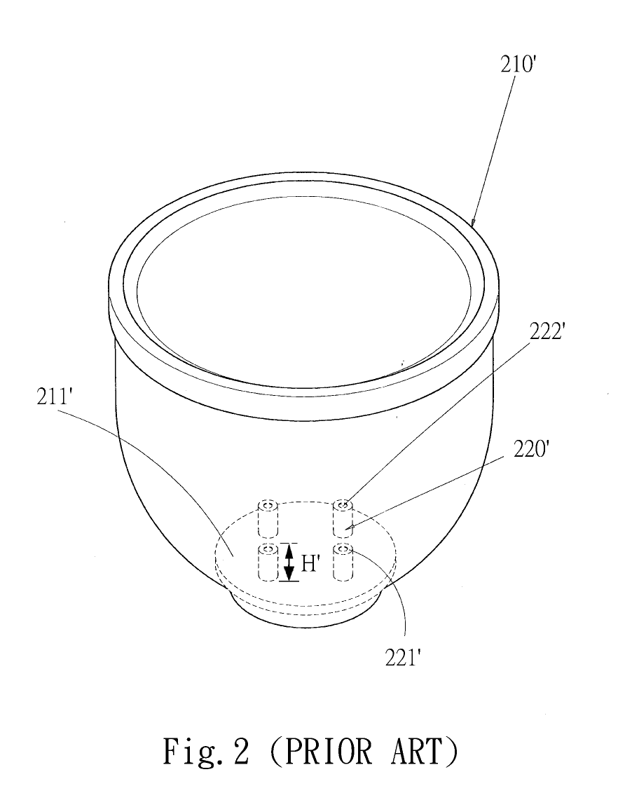

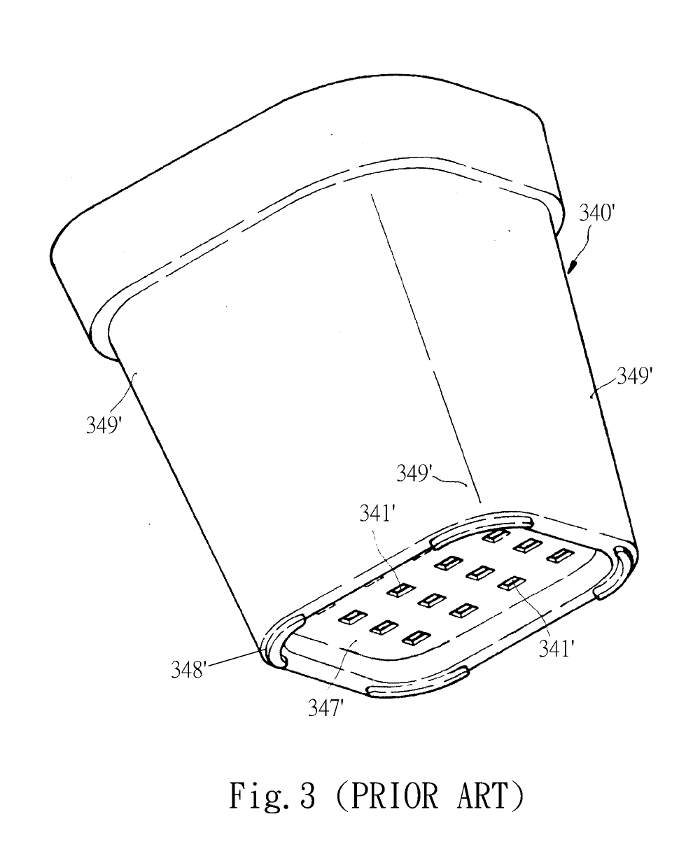

### DETAILED DESCRIPTIONS

The present invention will be fully described by way of preferred embodiments and appended drawings to facilitate the understanding of the technical features, contents and advantages of the present invention and the effect to be achieved by the present invention. It will be understood that the appended drawings are merely schematic representations and may not be illustrated according to actual scale and precise arrangement of the implemented creation. Therefore, the scope of protection of the present invention shall not be construed based on the scale and arrangement illustrated on the appended drawings and limited thereto.

Herein, the term “plant” includes any part, tissue and organ originating from any plants. For example, the “plant” includes a fruit, a flower, a tuber, a root, a stem, a leaf, a seed and the like.

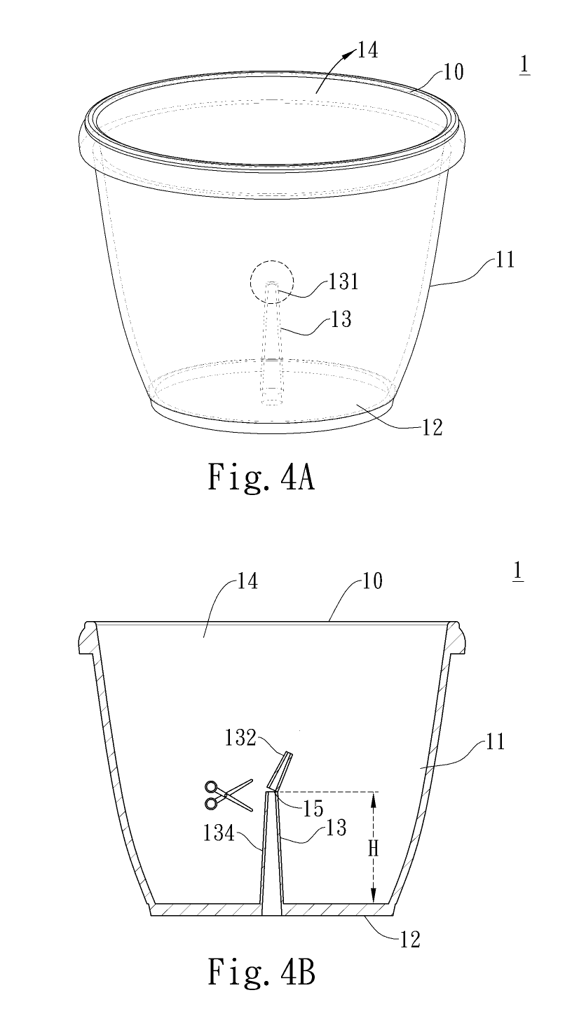

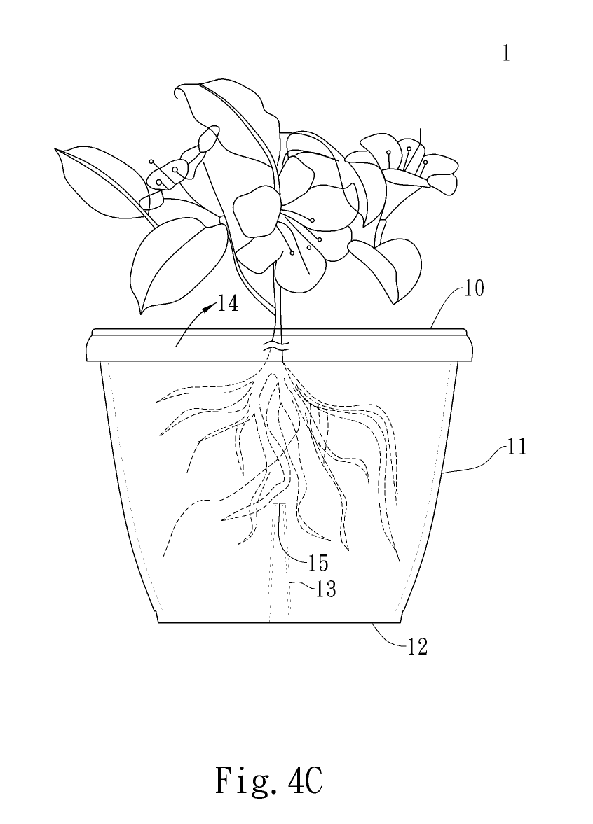

FIGS. 4A to 4C are schematic representation views showing a plant pot in accordance with a first embodiment of the present disclosure. In this embodiment, referring to FIG. 4A, the plant pot 1 is constructed by a pot section 10, which has a truncated conical shape. The pot section 10 is constructed by a side wall 11 and a bottom wall 12. The side wall 11 is extending from and surrounding the bottom wall 12, such that the side wall 11 and the bottom 12 together define an accommodation space 14 for receiving soil, water and plants therein.

As shown in FIG. 4A, the bottom wall 12 is provided with a ventilation section 13 extending from the bottom wall 12 and toward the inside of the accommodation space 14. The ventilation section 13 is hollow, and is initially, e.g. upon being manufactured with an open hole or an enclosed end, at a height, H, which is smaller than that of the side wall 11, distal to the bottom wall 12. In some embodiments, the distal end 131 of the ventilation section 13 is either an open hole, or is initially enclosed and can be cut to have an open hole for releasing excess water in the pot while providing ventilation for the pot. Before receiving the soil or the plant in the accommodation space 14, the ventilation section 13 is able to be separated into two portions 132 and 134 at a desirable height H measured from the bottom wall 12, as shown in FIG. 4B. Ventilation section 13 can be separated into the two portions 132 and 134 by, including but not limited to, trimming, cutting, sawing, snapping, twisting or a combination thereof. The portion 132 is able to be removed from the ventilation section 13, leaving the portion 134, and thereby a new ventilation hole 15 is formed and exposed at a position corresponding to the height H within the accommodation space 14. Depending on the differing growth conditions, e.g. the water content or the air circulation, required by different varieties of plants, the height H and thus the position of the ventilation hole 15 with respect to the pot section 10 and the accommodation space 14 are able to be determined and adjusted.

In this embodiment, the ventilation section 13 is shown having a conical shape. That is, the ventilation section 13 is tapered from the bottom wall 12, such that the diameter of the end of the ventilation section 13 that is proximate to the bottom wall 12 is decreasing with the transition thereof to the distal end 131. In this case, the height H at which the ventilation section 13 is separated into two portions 132 and 134 determines not only the position but also the area of the ventilation hole 15. With the increasing height H, the area of the ventilation hole 15 decreases, and thus the air circulation is able to be further influenced and/or adjusted.

In some embodiments, the thickness of the ventilation section wall 13 is smaller than the side wall 11 and bottom wall 12, in order to make above mentioned separation easier.

In some embodiments, the position and area of the ventilation hole 15 is able to be adjusted by separating the ventilation section 13 at a determined height H, to meet the specific needs of certain plants, as shown in FIG. 4C. In more specific terms, by separating the ventilation section 13 at a taller height H, the ventilation hole 15 as formed will be smaller, and will be applicable for some plants that need more water in soil. In the case that the plants need less water in soil, the ventilation hole 15 can be formed with a larger opening, by separating the ventilation section 13 at a position of a shorter height H, to allow an enhanced air circulation for the plant growth.

One of the advantages of the plant pot of the present invention is that, with the ventilation section designed in such this way, the empty plant pots are able to be stacked on and nested with one another, so as to save the space required for storage of multiple plant pots and the cost for transportation thereof.

The ventilation section 13 as shown in FIGS. 4A to 4C has a conical shape. However, it should be noted that in some alternative embodiments the shape of the ventilation section is able to be varied, including but not limited to a rectangle, cone, prism, cylinder, polygonal cylinder and irregular shape. In some embodiments, the ventilation section is able to be made of the same material as that of the pot section. In some other embodiments, the ventilation section is able to be made of a different material from that of the pot section. The ventilation section may be made of paper, plastic, wood, clay, ceramic or foam materials. In some embodiments, the ventilation section is made with a thickness less than that of the side wall of the plant pot, such that the ventilation section is able to be separated easily.

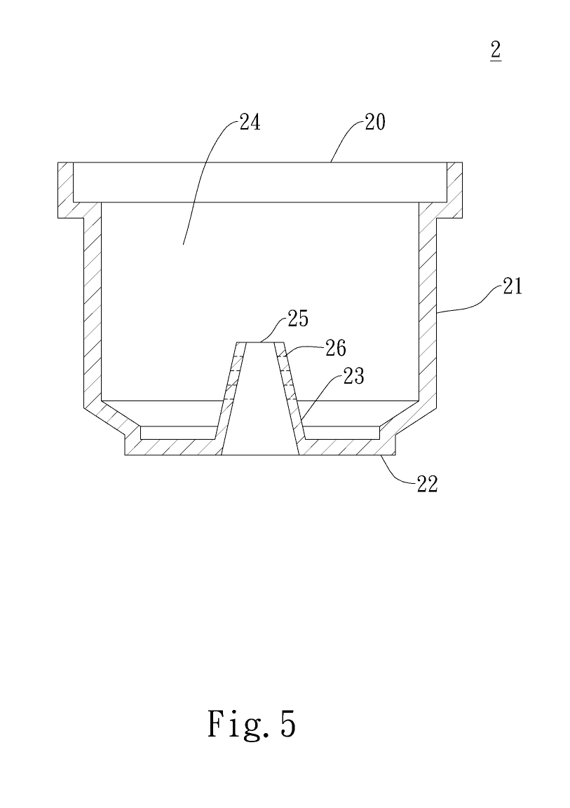

FIG. 5 is a schematic representation view of a plant pot in accordance with some embodiments of the present invention. In this embodiment, the ventilation section 23 is advantageously provided with a plurality of trim lines 26 formed thereon. These trim lines 26 are spaced apart from each other. The formation of trim lines 26 makes the ventilation section 23 separate into two portions more easily, for example, by snapping or twisting instead of cutting, sawing or trimming. In this embodiment, the trim lines 26 are formed on the surface of the ventilation section 23 by such as carving, while any other schemes known by a person skilled in the art is also able to be used.

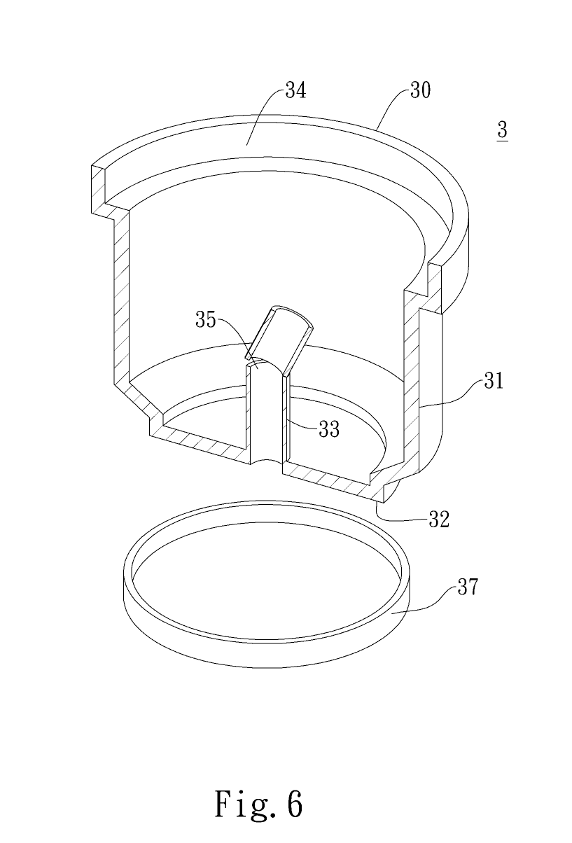

FIG. 6 shows a schematic representation view of a plant pot in accordance with a third embodiment of the present disclosure. The plant pot 3 of this embodiment is similar to the one as shown in FIGS. 4A to 4C. The plant pot 3 comprises a ventilation section 33 has a cylindrical shape. The plant pot 3 further includes a water collecting reservoir 37 positioned at the bottom of the plant pot 3 for collecting excess water flowing out of the plant pot 3 through the ventilation hole 35 when water is poured into the plant pot 3.

Compared to the conventional plant pots, the present disclosure provides an environment and condition more similar to those in nature, in such a way that the moisture of the soil increases as it gets deeper, while the soil in traditional plant pots dry faster on both the top and at the bottom because both ends are exposed to the air.

The present disclosure is able to preserve more water in the pot than traditional ones, resulting in less watering frequency is needed in taking care of plants therein. The soil in the pot is able to be kept wet for a longer period of time thus provides a steadier water supply to the plants.

The present invention is able to be utilized to provide a function of preserving more minerals and vital nutrients in the pots than traditional ones, as the excess water in pots only take away minerals and nutrients from the soil above the EVH. Planters are able to be utilized this character to put fertilizer at the bottom of an empty pot before adding soil. The fertilizer therein last longer and the amount applied is able to be reduced.

The present disclosure provides a possible solution to the disadvantages of traditional planting pots. Planting pots are low price merchandise. An invention with a simple design helps its commercial appeal.

### Experiments and Results

The differences in development of plants grown in the conventional plant pot (e.g., the control group) and in the plant pot according to the present invention (e.g., the experimental group), respectively, are summarized in Table 1. The plants are the same and are treated in the same manner according to the first embodiment. The control group is conducted in duplicate, while the experimental group is in quadruplicate. The experiments are started in Los Angeles, Calif. on Dec. 2, 2012 (Winter).

TABLE 1

| Days of Observation | The control group | The experimental group |
|---|---|---|
| 0 day (Dec. 02, 2012) | no bud | no bud |
| 34 days (Jan. 05, 2013) | no bud | Formation of one bud in |
| | | each of the four pots |
| | | observed |
| 57 days (Jan. 28, 2013) | Formation of | New Leaves in one pot; |
| | 1 bud observed | one bud in each of the |
| | | other three pots observed |
| 115 days (Mar. 27, 2013) | Formation of | New stems of 3″ to 7″ are |
| | 1 bud in one | observed in each of the |
| | pot and a new | four pots. |
| | stem of 2″ in | |
| | the other pot | |
| 124 days (Apr. 05, 2013) | New stems | New stems and leaves of |
| | and leaves of | 5″ to 8″ observed in each |
| | 1″ and 4″ | of the four plant pots |
| | observed in | |
| | plant pots. | |

The formation of new buds is earlier and the length of new stems per plant in the experimental group is greater per plant than in the control group.

The following Table 2 shows the moisture of soil in the control group and that in the experimental group according to the first embodiment. A digital plus moisture meter is used to measure the moisture of soil for each of the plant pots. The scale of the meter for measuring the moisture of soil is provided from 0 to 9.9. This experiment started in Los Angeles, Calif. on Apr. 22, 2013.

TABLE 2

| Days of Measurement | The control group | The experimental group |
|---|---|---|
| 0 day | 9.9 | 9.9 |
| 3 days | 3.0 | 8.2 |
| 6 days | 1.5 | 7.0 |
| 8 days | 0 | 3.5 |

The results show that the moisture of soil in the control group is significantly less than that in the experimental group. It is understood by those skilled in the art that plant pots according to the present invention have an advantage in maintaining soil moisture, which is important to plant growth, at the same time reducing the watering needed, and requiring less care.

The arrangement of the aforementioned structure in the third embodiment has been detailed in the first embodiment thus no further description will be provided. Moreover, please note that the materials of the recess portion, the walls of the pot section and the water collecting reservoir 45 is able to be varied. In practice, therefore, a few different shapes and sizes of the plant pot are able to be used with the adjustable ventilation hole.

From the foregoing, the plant pot is a novel device that is simple and inexpensive in construction for easy manufacture and is able to be easily used at home or in other environments for growing and displaying plants. The plant pot of the present invention achieves these objectives by providing an inward recess portion with an adjustable height for manually adjusting the position of the ventilation hole. The position of the ventilation hole corresponds to the adjustable height, so that the plant pot is able to be used for different plant species. Using the device of the present invention, the position of ventilation hole is easily adjusted for a particular purpose. The position of the ventilation hole and the height of the recess portion are easily adjusted by cutting, sawing, trimming or twisting the recess portion. Moreover, according to the experimental results, the plant pot of the present invention extends the moisture content for more days, which decreases the frequency of watering. This is especially beneficial to those who usually forget to water or are too busy to water the plants.

The embodiments depicted above are exemplary and are not intended to limit the scope of the present invention. Any change or alteration with equivalent efficiency made without departing from the spirit and scope of this creation falls within the scope of the appended claims.

What is claimed is:

1. A plant pot with elevated ventilation hole (EVH), comprising:
a pot section having a bottom wall and a side wall extending from and surrounding said bottom wall, said bottom wall and said side wall together defining an accommodation space for receiving soil and plants therein;
wherein said bottom wall is provided with a ventilation section extending therefrom and toward an inside of said accommodation space;
wherein said ventilation section comprises a hollow body and is provided with a ventilation hole at an end distal to said bottom wall;
wherein said ventilation section is separable into two portions; and
wherein said height is capable of being determined and adjusted.

2. The plant pot of claim 1, wherein said ventilation section is separated by means of at least one of trimming, cutting, sawing, snapping, twisting and the combination thereof.

3. The plant pot of claim 1, wherein said ventilation section is provided with a plurality of trim lines which are formed thereon and spaced from each other.

4. The plant pot of claim 3, wherein said ventilation section is separable at one selected line from said plurality of trim lines so as to adjust said height and thus said position of said ventilation hole.

5. The plant pot of claim 1, wherein said ventilation section has a conical shape, a polygonal cylindrical shape, a cylindrical shape or an irregular shape.

6. The plant pot of claim 1, wherein said side wall has a thickness greater than that of said ventilation section.

7. The plant pot of claim 1, wherein said ventilation section is made of the same material as that of said pot section.

8. The plant pot of claim 1, wherein said ventilation section is made of a different material from that of said pot section.

9. The plant pot of claim 1, wherein said ventilation section is made of paper, plastic, wood, clay, ceramic or foam materials.

10. The plant pot of claim 1, further comprising a water collecting reservoir disposed at the bottom of said plant pot for collecting excess water flowing out of said plant pot.

11. A plant pot with elevated ventilation hole (EVH), comprising:
a pot section having a bottom wall and a side wall extending from and surrounding said bottom wall, said bottom wall and said side wall together defining an accommodation space for receiving soil and plants therein,
wherein said bottom wall is provided with a ventilation section extending therefrom and toward an inside of said accommodation space,
wherein said ventilation section comprises a hollow body and is closed at an end distal to said bottom wall,
wherein said ventilation section is separable into two portions, and
wherein said height is capable of being predetermined and adjusted.

12. The plant pot of claim 11, wherein said ventilation section is separable by means of at least one of trimming, cutting, sawing, snapping, twisting and the combination thereof.

13. The plant pot of claim 11, wherein said ventilation section is provided with a plurality of trim lines which are formed thereon and spaced from each other.

14. The plant pot of claim 13, wherein said ventilation section is separable at one selected line from said plurality of trim lines so as to adjust said height and thus said position of said ventilation hole.

15. The plant pot of claim 11, wherein said ventilation section has a conical shape, a polygonal cylindrical shape, a cylindrical shape or an irregular shape.

16. The plant pot of claim 11, wherein said side wall has a thickness greater than that of said ventilation section.

17. The plant pot of claim 11, wherein said ventilation section is made of the same material as that of said pot section.

18. The plant pot of claim 11, wherein said ventilation section is made of a different material from that of said pot section.

19. The plant pot of claim 11, wherein said ventilation section is made of paper, plastic, wood, clay, ceramic or foam materials.

20. The plant pot of claim 11, further comprising a water collecting reservoir disposed at the bottom of said plant pot for collecting excess water flowing out of said plant pot.
